(19) United States
(12) Patent Application Publication
(10) Pub. No.: US 2010/0119774 A1
(43) Pub. Date: May 13, 2010

(54) WATER-REPELLENT, OIL-REPELLENT, AND ANTIFOULING ANTIREFLECTION FILM AND METHOD FOR MANUFACTURING THE SAME, LENS, GLASS SHEET, AND GLASS COATED WITH THE SAME, AND OPTICAL APPARATUS, SOLAR ENERGY SYSTEM, AND DISPLAY EQUIPPED WITH THESE COMPONENTS

(76) Inventor: Kazufumi Ogawa, Awa-shi (JP)

Correspondence Address: FOLEY & LARDNER LLP, 150 EAST GILMAN STREET, P.O. BOX 1497, MADISON, WI, 53701-1497, US

(21) Appl. No.: 12/593,874

(22) PCT Filed: Mar. 31, 2008
(86) PCT No.: PCT/JP2008/056373

§ 371 Date: Oct. 27, 2009

(30) Foreign Application Priority Data
Mar. 30, 2007 (JP) 2007-093641

(51) Int. Cl. B32B 5/02; B32B 3/00; B05D 3/00; B05D 3/10

(52) U.S. Cl. 428/142; 428/143; 428/148; 428/149; 427/352; 427/337; 427/340

(57) ABSTRACT

A water-repellent, oil-repellent, and antifouling antireflection film having water-repellent, oil-repellent, and antifouling properties, a water liberation property, and durability; a method for manufacturing such an antireflection film; a lens, a glass sheet, and glass having a surface coated with a water-repellent, oil-repellent, and antifouling antireflection film; and an optical apparatus, a solar energy system, and a display equipped with such components are provided.

The glass sheet 10 coated with a water-repellent, oil-repellent, and antifouling antireflection film has a plate substrate 5, water-repellent, oil-repellent, and antifouling transparent fine particles 1a fused onto the substrate 5, and a film 8 composed of a water-repellent, oil-repellent, and antifouling substance and coating a portion of a surface of the substrate 5 excluding the portion onto which the transparent fine particles 1a are fused, and the surface of each transparent fine particle 1 is partially fused onto the surface of the substrate 5 and the remaining exposed surface thereof is coated with the film 8 composed of a water-repellent, oil-repellent, and antifouling substance.

### TECHNICAL FIELD

The present invention relates to a water-repellent, oil-repellent, and antifouling antireflection film having high durability and a method for manufacturing such an antireflection film, as well as a lens, a glass sheet, and glass having a surface coated with a water-repellent, oil-repellent, and antifouling antireflection film, and an optical apparatus, a solar energy system, and a display equipped with these components.

### BACKGROUND ART

It is widely known that chemical adsorption in a liquid phase using a chemisorption solution containing a chlorosilane adsorbent having a carbon fluoride group and a non-aqueous organic solvent results in formation of a water-repellent, oil-repellent, and antifouling chemisorption monomolecular film (e.g., see Patent Document 1).

The principle of manufacturing of such a chemisorption monomolecular film in a solution consists of formation of a monomolecular film using a dehydrochloride reaction between active hydrogen existing on the surface of a glass substrate, such as a hydroxyl group, and a chlorosilyl group contained in a chlorosilane adsorbent.

[Patent Document 1] Japanese Unexamined Patent Application No. H4-132631

### DISCLOSURE OF INVENTION

### Problems to be Solved by the Invention

However, known chemisorption films use only chemical bonding between an adsorbent and a flat surface of a substrate, and thus achieve a water droplet contact angle of approximately 120° at maximum. Therefore, they have a problem that the water-repellent, oil-repellent, and antifouling properties and the water liberation property are insufficient for spontaneous detachment of water droplets and dirt. Furthermore, they are also insufficient in terms of resistance against wear, weather, or the like.

The present invention is made to address these problems and intended to provide a water-repellent, oil-repellent, and antifouling antireflection film having water-repellent, oil-repellent, and antifouling properties, a water droplet liberation property (also called a water-sheeting property), and resistance against wear, weather, or the like; a method for manufacturing such an antireflection film; a lens, a glass sheet, and glass coated with a water-repellent, oil-repellent, and antifouling antireflection film; and an optical apparatus, a solar energy system, and a display equipped with these components.

### Means for Solving the Problems

A water-repellent, oil-repellent, and antifouling antireflection film according to the first aspect of the present invention and meeting the objective described above includes a plate substrate, water-repellent, oil-repellent, and antifouling transparent fine particles fused onto a surface of the substrate, and a film composed of a water-repellent, oil-repellent, and antifouling substance coating a portion of the surface of the substrate excluding the portion onto which the transparent fine particles are fused.

Here, the term “fused” means the eutectic state of a portion of the substrate and a portion of the transparent fine particles.

In the water-repellent, oil-repellent, and antifouling antireflection film according to the first aspect of the present invention, it is preferable that the surface of each transparent fine particle is partially fused onto the surface of the substrate and the remaining exposed surface thereof is coated with the film composed of a water-repellent, oil-repellent, and antifouling substance.

It is preferable that the surface of each transparent fine particle is partially fused onto the surface of the glass substrate and the remaining exposed surface thereof is coated with the film composed of a water-repellent, oil-repellent, and antifouling substance.

In the water-repellent, oil-repellent, and antifouling antireflection film according to the first aspect of the present invention, it is preferable that the film composed of a water-repellent, oil-repellent, and antifouling substance is covalently bound to a surface of each transparent fine particle and the surface of the substrate.

In the water-repellent, oil-repellent, and antifouling antireflection film according to the first aspect of the present invention, the transparent fine particles may include transparent fine particles with different particle diameters.

In the water-repellent, oil-repellent, and antifouling antireflection film according to the first aspect of the present invention, the film composed of a water-repellent, oil-repellent, and antifouling substance preferably contains —CF₃ groups.

In the water-repellent, oil-repellent, and antifouling antireflection film according to the first aspect of the present invention, the transparent fine particles are preferably any of silica fine particles, alumina fine particles, or zirconia fine particles being translucent and having a softening point higher than that of the surface of the substrate.

In the water-repellent, oil-repellent, and antifouling antireflection film according to the first aspect of the present invention, the particle diameter of each transparent fine particle is preferably smaller than 400 nm.

In the water-repellent, oil-repellent, and antifouling antireflection film according to the first aspect of the present invention, it is preferable that a water contact angle is equal to or larger than 140°.

In the water-repellent, oil-repellent, and antifouling antireflection film according to the first aspect of the present invention, it is preferable that a transparent film that is fused onto the transparent fine particles at a lower temperature than the substrate is used to fuse the transparent fine particles onto the surface of the glass substrate and the film composed of a water-repellent, oil-repellent, and antifouling substance coats a portion of the substrate excluding the portion onto which the transparent fine particles are fused through the transparent film.

A lens according to the second aspect of the present invention and meeting the objective described earlier has a surface coated with the water-repellent, oil-repellent, and antifouling antireflection film according to the first aspect of the present invention.

A glass sheet according to the third aspect of the present invention and meeting the objective described earlier has a surface coated with the water-repellent, oil-repellent, and antifouling antireflection film according to the first aspect of the present invention.

Glass according to the fourth aspect of the present invention and meeting the objective described earlier has a surface coated with the water-repellent, oil-repellent, and antifouling antireflection film according to the first aspect of the present invention.

An optical apparatus according to the fifth aspect of the present invention and meeting the objective described earlier is equipped with a lens having a surface coated with the water-repellent, oil-repellent, and antifouling antireflection film according to the first aspect of the present invention.

A solar energy system according to the sixth aspect of the present invention and meeting the objective described earlier is equipped with a glass sheet having a surface coated with the water-repellent, oil-repellent, and antifouling antireflection film according to the first aspect of the present invention.

A display according to the seventh aspect of the present invention and meeting the objective described earlier is equipped with glass having a surface coated with the water-repellent, oil-repellent, and antifouling antireflection film according to the first aspect of the present invention.

A method for manufacturing a water-repellent, oil-repellent, and antifouling antireflection film according to the eighth aspect of the present invention and meeting the objective described above includes a step C of preparing a fine particle dispersion liquid in which transparent fine particles are dispersed;

a step D of attaching the transparent fine particles to a surface of a substrate by applying the fine particle dispersion liquid to the surface of the substrate and then drying it;

a step E of fusing the transparent fine particles onto the surface of the substrate by heating the substrate having a surface to which the transparent fine particles are attached at a temperature lower than the softening point of the transparent fine particles;

a step F of washing away a portion of the transparent fine particles that is not fused onto the surface of the substrate; and

a step G of forming a film composed of a water-repellent, oil-repellent, and antifouling substrate on a fine-particle-fused substrate, i.e., the substrate having a surface onto which the transparent fine particles are fused.

The method for manufacturing a water-repellent, oil-repellent, and antifouling antireflection film according to the eighth aspect of the present invention may further include a step B of coating a surface of the substrate with a transparent film that is insoluble in the fine particle dispersion liquid and fused onto the transparent fine particles at a lower temperature than the substrate before the step D.

In the method for manufacturing a water-repellent, oil-repellent, and antifouling antireflection film according to the eighth aspect of the present invention, a sol-gel method may be used to form the transparent film.

In the method for manufacturing a water-repellent, oil-repellent, and antifouling antireflection film according to the eighth aspect of the present invention, it is preferable that the temperature used in the heating process in the step E is at least 250° C. and lower than the softening points of the substrate and the transparent fine particles.

The method for manufacturing a water-repellent, oil-repellent, and antifouling antireflection film according to the eighth aspect of the present invention preferably further includes a step A of coating the transparent fine particles with a monomolecular film composed of a first silane compound having a linear group, in which transparent fine particles “a” are dispersed in a first chemisorption solution containing the first silane compound and a non-aqueous organic solvent to initiate a reaction between a silyl group of the first silane compound and a reactive group existing on a surface of each transparent fine particle “a”. Additionally, the heating process in the step E is preferably carried out in an atmosphere containing oxygen.

In the method for manufacturing a water-repellent, oil-repellent, and antifouling antireflection film according to the eighth aspect of the present invention, it is preferable that an organic solvent is used to prepare the fine particle dispersion liquid and the linear group is a carbon fluoride group.

In the method for manufacturing a water-repellent, oil-repellent, and antifouling antireflection film according to the eighth aspect of the present invention, it is acceptable that water, an alcohol, or a mixed solvent thereof is used to prepare the fine particle dispersion liquid and the linear group is a hydrocarbon group.

In the method for manufacturing a water-repellent, oil-repellent, and antifouling antireflection film according to the eighth aspect of the present invention, the formation of the film composed of a water-repellent, oil-repellent, and antifouling substance in the step G can be achieved by bringing a second chemisorption solution containing a second silane compound having a carbon fluoride group and a non-aqueous organic solvent into contact with the fine-particle-fused substrate to initiate a reaction between a silyl group of the second silane compound and a reactive group existing on a surface of the fine-particle-fused substrate.

In the step G in the method for manufacturing a water-repellent, oil-repellent, and antifouling antireflection film according to the eighth aspect of the present invention, it is preferable that an unreacted portion of the second silane compound is washed away after the reaction between a silyl group and a reactive group.

In the method for manufacturing a water-repellent, oil-repellent, and antifouling antireflection film according to the eighth aspect of the present invention, the first silane compound contained in the first chemisorption solution and/or the second silane compound contained in the second chemisorption solution is preferably an alkoxysilane compound.

In the method for manufacturing a water-repellent, oil-repellent, and antifouling antireflection film according to the eighth aspect of the present invention, the first silane compound contained in the first chemisorption solution and/or the second silane compound contained in the second chemisorption solution may be a halosilane compound.

In the method for manufacturing a water-repellent, oil-repellent, and antifouling antireflection film according to the eighth aspect of the present invention, the first silane compound contained in the first chemisorption solution and/or the second silane compound contained in the second chemisorption solution is preferably an isocyanate silane compound.

In the method for manufacturing a water-repellent, oil-repellent, and antifouling antireflection film according to the eighth aspect of the present invention, those containing the alkoxysilane compound described above of the first and second chemisorption solutions may further contain one or more compounds selected from the group consisting of metal carboxylate salts, metal carboxylate esters, polymers based on a metal carboxylate salt, chelates based on a metal carboxylate salt, titanate esters, and chelates based on a titanate ester as a condensation catalyst.

In the method for manufacturing a water-repellent, oil-repellent, and antifouling antireflection film according to the eighth aspect of the present invention, those containing the alkoxysilane compound described above of the first and second chemisorption solutions may further contain one or more compounds selected from the group consisting of ketimine compounds, organic acids, aldimine compounds, enamine compounds, oxazolidine compounds, and aminoalkylalkoxysilane compounds as a condensation catalyst.

In the method for manufacturing a water-repellent, oil-repellent, and antifouling antireflection film according to the eighth aspect of the present invention, one or more compounds selected from the group consisting of ketimine compounds, organic acids, aldimine compounds, enamine compounds, oxazolidine compounds, and aminoalkylalkoxysilane compounds may be additionally used as promoter(s).

### ADVANTAGES

In the water-repellent, oil-repellent, and antifouling antireflection films according to claims 1 to 9, a surface of a plate substrate is coated with water-repellent, oil-repellent, and antifouling transparent fine particles and a film composed of a water-repellent, oil-repellent, and antifouling substance, and thus the surface of the substance has water-repellent, oil-repellent, and antifouling properties, a water droplet liberation property, and durability.

In particular, in the water-repellent, oil-repellent, and antifouling antireflection film according to claim 2, each transparent fine particle is fused onto the surface of the glass substrate at a portion of the surface thereof, and thus the surface has a complicated concavo-convex structure, and the remaining exposed portion is coated with a film composed of a water-repellent, oil-repellent, and antifouling substance and thus has high water-repellent, oil-repellent, and antifouling properties.

The water-repellent, oil-repellent, and antifouling antireflection film according to claim 3 has improved durability because the film composed of a water-repellent, oil-repellent, and antifouling substance contained therein is covalently bound to a surface of each transparent fine particle and a surface of the glass substrate.

The water-repellent, oil-repellent, and antifouling antireflection film according to claim 4 contains transparent fine particles with different particle diameters and thus the surface shape of the water-repellent, oil-repellent, and antifouling glass sheet has a fractal nature, and accordingly has improved water-repellent, oil-repellent, and antifouling properties.

The water-repellent, oil-repellent, and antifouling antireflection film according to claim 5 has improved water-repellent, oil-repellent, and antifouling properties because the film composed of a water-repellent, oil-repellent, and antifouling substance contained therein contains —CF₃ groups.

In the water-repellent, oil-repellent, and antifouling antireflection film according to claim 6, the transparent fine particles are any of silica fine particles, alumina fine particles, or zirconia fine particles being translucent and having a softening point higher than that of the surface of the glass substrate, and thus the transparent fine particles can be fused onto the surface of the glass substrate without being deformed.

The water-repellent, oil-repellent, and antifouling antireflection film according to claim 7 exhibits less scattering of visible light and has high translucency because the particle diameter of each transparent fine particle contained therein is smaller than 400 nm and accordingly smaller than visible wavelengths.

In the water-repellent, oil-repellent, and antifouling antireflection film according to claim 8, the water droplet downslide angle is small because the water contact angle is equal to or larger than 140°. Therefore, such an antireflection film retains substantially no water droplets.

In the water-repellent, oil-repellent, and antifouling antireflection film according to claim 9, a transparent film that is fused onto the transparent fine particles at a lower temperature than the glass substrate is used to fuse the transparent fine particles onto the surface of the glass substrate and thus the temperature required in the heating process for fusion can be lowered. Therefore, thermal deformation of the transparent fine particles during fusion is prevented.

The lens according to claim 10, the glass sheet according to claim 11, and the glass according to claim 12 individually have a surface coated with a water-repellent, oil-repellent, and antifouling antireflection film and thus their surfaces have water-repellent, oil-repellent, and antifouling properties, a water droplet liberation property, and durability.

The optical apparatus according to claim 13 is equipped with a lens having a surface coated with a water-repellent, oil-repellent, and antifouling film, and thus the lens has water-repellent, oil-repellent, and antifouling properties, a water droplet liberation property, and durability. As a result, the optical apparatus is relieved from the necessity of frequent maintenance and has an extended life.

The solar energy system according to claim 14 is equipped with a glass sheet having a surface coated with a water-repellent, oil-repellent, and antifouling film, and thus the glass sheet has water-repellent, oil-repellent, and antifouling properties, a water droplet liberation property, and durability. As a result, the efficiency of solar absorption is improved and the frequency of maintenance is reduced, thereby improving the efficiency and rate of operation of the solar energy system.

The display according to claim 15 is equipped with glass having a surface coated with a water-repellent, oil-repellent, and antifouling film, and thus the glass has water-repellent, oil-repellent, and antifouling properties, a water droplet liberation property, and durability. As a result, the display shows clearer images and is relieved from the necessity of frequent maintenance (cleaning of the face plate).

In the methods for manufacturing a water-repellent, oil-repellent, and antifouling antireflection film according to claims 16 to 30, a surface of a substrate is coated with a film composed of a water-repellent, oil-repellent, and antifouling substance and thus the surface of the substrate has water-repellent, oil-repellent, and antifouling properties, a water droplet liberation property, and durability.

The method for manufacturing a water-repellent, oil-repellent, and antifouling antireflection film according to claim 17 further includes a step B of coating a surface of the substrate with a transparent film that is fused onto the transparent fine particles at a lower temperature than the substrate before the step D. Therefore, the temperature used in the heating process in the step E can be lowered.

The method for manufacturing a water-repellent, oil-repellent, and antifouling antireflection film according to claim 18 facilitates formation of the transparent film because a sol-gel method is used to form the transparent film in this method.

In the method for manufacturing a water-repellent, oil-repellent, and antifouling antireflection film according to claim 19, the temperature used in the heating process in the step E is at least 250° C. and lower than the softening points of the glass substrate and the transparent fine particles. Therefore, deformation of the transparent fine particles during fusion is prevented.

The method for manufacturing a water-repellent, oil-repellent, and antifouling antireflection film according to claim 20 further includes a step A of coating the transparent fine particles with a monomolecular film composed of a first silane compound having a linear group, in which transparent fine particles “a” are dispersed in a first chemisorption solution containing the first silane compound and a non-aqueous organic solvent to initiate a reaction between a silyl group of the first silane compound and a reactive group existing on a surface of each transparent fine particle “a”. Additionally, in the step C, transparent fine particles each having a surface coated with a monomolecular film composed of the first silane compound are used to prepare the fine particle dispersion solution. As a result, the transparent fine particles existing in the fine particle dispersion liquid is prevented from aggregating and uniformly dispersed.

In this method, the heating process in the step E is carried out in an atmosphere containing oxygen, and complete decomposition and removal of the monomolecular film of the first silane compound can be achieved even at a low temperature.

In the method for manufacturing a water-repellent, oil-repellent, and antifouling antireflection film according to claim 21, an organic solvent is used to prepare the fine particle dispersion liquid and the linear group of the first silane compound is a carbon fluoride group, and thus the surface energy of each transparent fine particle is small enough to prevent aggregation of the transparent fine particles consistently.

In the method for manufacturing a water-repellent, oil-repellent, and antifouling antireflection film according to claim 22, water, an alcohol, or a mixed solvent thereof is used to prepare the fine particle dispersion liquid and the linear group of the first silane compound is a hydrocarbon group, and this enables preparing a safer fine particle dispersion liquid at a lower cost.

In the method for manufacturing a water-repellent, oil-repellent, and antifouling antireflection film according to claim 23, the formation of the film composed of a water-repellent, oil-repellent, and antifouling substance in the step G is achieved by bringing a second silane compound having a carbon fluoride group into contact with the fine-particle-fused glass substrate to initiate a reaction between a silyl group of the second silane compound and a reactive group existing on a surface of the fine-particle-fused substrate, and thus the durability of the film composed of a water-repellent, oil-repellent, and antifouling substance is improved.

In the method for manufacturing a water-repellent, oil-repellent, and antifouling antireflection film according to claim 24, an unreacted portion of the second silane compound is washed away after the reaction between a silyl group and a reactive group in the step G. This means that only a film composed of a water-repellent, oil-repellent, and antifouling substance that is covalently bound to a surface of the fine-particle-fused substrate is formed and thus the water-repellent, oil-repellent, and antifouling glass sheet has improved water-repellent, oil-repellent, and antifouling properties and durability.

In the method for manufacturing a water-repellent, oil-repellent, and antifouling antireflection film according to claim 25, the first silane compound and/or the second silane compounds is an alkoxysilane compound, which generates no hazardous hydrogen chloride during a reaction with a reactive group. As a result, water-repellent, oil-repellent, and antifouling antireflection films can be manufactured in a safer way with corrosion of facilities used to manufacture the antireflection films being prevented and the amount of acidic wastewater discharged being reduced.

In the method for manufacturing a water-repellent, oil-repellent, and antifouling antireflection film according to claim 26, the first silane compound and/or the second silane compounds is a halosilane compound, which is highly reactive with a reactive group. As a result, water-repellent, oil-repellent, and antifouling antireflection films can be manufactured in a more efficient way with the need for adding a catalyst being eliminated.

In the method for manufacturing a water-repellent, oil-repellent, and antifouling antireflection film according to claim 27, the first silane compound and/or the second silane compounds is an isocyanate silane compound, which generates no hazardous hydrogen chloride during a reaction with a reactive group and is highly reactive. As a result, corrosion of facilities used to manufacture the antireflection films is prevented, the amount of acidic wastewater discharged is reduced, and the need for adding a catalyst is eliminated.

In the method for manufacturing a water-repellent, oil-repellent, and antifouling antireflection film according to claim 29, those containing an alkoxysilane compound of the first and second chemisorption solutions further contain at least one compound selected from the group consisting of metal carboxylate salts, metal carboxylate esters, polymers based on a metal carboxylate salt, chelates based on a metal carboxylate salt, titanate esters, and chelates based on a titanate ester as a condensation catalyst. As a result, the time required for a reaction between the alkoxysilane compound and a reactive group is shortened, thereby making manufacturing of water-repellent, oil-repellent, and antifouling glass sheets more efficient.

In the method for manufacturing a water-repellent, oil-repellent, and antifouling antireflection film according to claim 29, those containing an alkoxysilane compound of the first and second chemisorption solutions further contain at least one compound selected from the group consisting of ketimine compounds, organic acids, aldimine compounds, enamine compounds, oxazolidine compounds, and aminoalkylalkoxysilane compounds. As a result, the time required for a reaction between the alkoxysilane compound and an active hydrogen group is shortened, thereby making manufacturing of water-repellent, oil-repellent, and antifouling glass sheets more efficient.

In the method for manufacturing a water-repellent, oil-repellent, and antifouling antireflection film according to claim 30, at least one compound selected from the group consisting of ketimine compounds, organic acids, aldimine compounds, enamine compounds, oxazolidine compounds, and aminoalkylalkoxysilane compounds are additionally used as a promoter, and thus the time required for formation of the film composed of a water-repellent, oil-repellent, and antifouling substance is further shortened.

### BEST MODE FOR CARRYING OUT THE INVENTION

Hereinafter, a glass sheet having a surface coated with a water-repellent, oil-repellent, and antifouling antireflection film according to an embodiment of the present invention is described with reference to drawings.

As shown in FIG. 1, a glass sheet 10 for a solar water heater (an example of the solar energy system) according to an embodiment of the present invention (hereinafter, referred to as a “glass sheet”) has a plate glass substrate 5; silica fine particles 1a (an example of the water-repellent, oil-repellent, and antifouling transparent fine particles) fused onto a surface of the glass substrate 5 through a silica-based transparent film 6, an example of the transparent metal oxide film; and a chemisorption monomolecular film 8 containing carbon fluoride groups and coating a portion of the surface of the glass substrate excluding the portion onto which the silica fine particles are fused, an example of a water-repellent, oil-repellent, and antifouling film.

A method for manufacturing the glass sheet 10 includes the following steps: (FIGS. 2A and 2B) a step A of preparing silica fine particles 4 each having a surface coated with a monomolecular film 3 composed of a first silane compound having a linear group, in which silica fine particles 1, an example of the transparent fine particles (transparent fine particles “a” as a raw material), are dispersed in a first chemisorption solution containing the first silane compound and a non-aqueous organic solvent to initiate a reaction between a silyl group of the first silane compound and a hydroxyl group 2 (an example of the reactive group) existing on a surface of each silica fine particle 1; (FIG. 3) a step B of coating a surface of a glass substrate 5 with a silica-based transparent film 6; a step C of preparing a fine particle dispersion liquid in which the silica fine particles 4 each having a surface coated with a monomolecular film 3 composed of the first silane compound are dispersed; (FIG. 4A) a step D of attaching the silica fine particles 4 to the silica-based transparent film 6 coating the surface of the glass substrate 5 by applying the fine particle dispersion liquid to the surface of the glass substrate 5 (more specifically, a surface of the silica-based transparent film 6) and then drying it; a step E of preparing a concavo-convex glass substrate 7 coated with silica fine particles 1a fused thereonto (an example of the fine-particle-fused glass substrate) by heating the glass substrate 5 having a surface to which the silica fine particles 4 are attached in order to fuse the silica fine particles 4 onto the surface of the glass substrate 5 through the silica-based transparent film 6; a step F of washing away a portion of the silica fine particles 4 that is not fused onto the surface of the glass substrate 5; and a step G of forming a chemisorption monomolecular film 8 containing carbon fluoride groups on a surface of the concavo-convex glass substrate 7.

The steps A to G are described in detail below.

In the step A, silica fine particles 4 each having a surface coated with a monomolecular film 3 composed of a first silane compound are prepared.

To avoid a loss of transparency of the resulting glass sheet 10, it is preferable that the particle diameter of each silica fine particle 1 used to prepare the silica fine particles 4 each having a surface coated with a monomolecular film 3 composed of a first silane compound is smaller than visible wavelengths (380 to 700 nm). More specifically, the particle diameter of each silica fine particle 1 is preferably in the range of 10 to 400 nm, more preferably in the range of 10 to 300 nm, and much more preferably in the range of 10 to 100 nm. Although individual silica fine particles 1 may have the same particle diameter, a combination of silica fine particles with two or more different particle diameters is preferable because it provides a water-repellent, oil-repellent, and antifouling glass sheet 11 having a fractal nature on the surface (see FIG. 5), thereby improving water-repellent, oil-repellent, and antifouling properties.

In this embodiment, silica fine particles are used as the transparent fine particles. However, any translucent fine particles each having a hydroxyl group, an amino group, or any other active hydrogen group reactive with an alkoxysilyl group and a halosilyl group (an example of the reactive group) and a softening point higher than that of a glass substrate to be used may be used instead.

Examples of applicable transparent fine particles other than silica fine particles include fine particles of alumina, zirconia, or the like.

The first chemisorption solution used to prepare the silica fine particles 4 each having a surface coated with a monomolecular film 3 composed of a first silane compound is prepared by mixing the first silane compound, a condensation catalyst used to promote the condensation reaction between a silyl group and a hydroxyl group 2 existing on a surface of each silica fine particle 1, and a non-aqueous organic solvent.

The first silane compound is an alkoxysilane compound shown by either Chemical Formula 1 or 2 shown below.

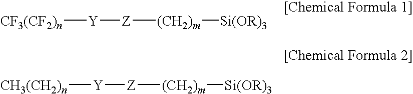

In Chemical Formulae 1 and 2, m represents an integer of 5 to 20, n represents an integer of 0 to 9, and R represents an alkyl group having one to four carbon atoms.

Also, Y represents either (CH₂)ₖ (k represents an integer of 1 to 3) or a single bond, and Z represents any of O (ether oxygen), COO, Si(CH₃)₂, and a single bond.

Specific examples of an alkoxysilane compound that can be used as the first silane compound include the alkoxysilane derivatives containing a carbon fluoride group (1) to (12) and the alkoxysilane derivatives containing a hydrocarbon group (21) to (32), listed below:

(1) CF₃CH₂O(CH₂)₁₅Si(OCH₃)₃

(2) CF₃(CH₂)₃Si(CH₃)₂(CH₂)₁₅Si(OCH₃)₃

(3) CF₃(CF₂)₅(CH₂)₂Si(CH₃)₂(CH₂)₉Si(OCH₃)₃

(4) CF₃(CF₂)₇(CH₂)₂Si(CH₃)₂(CH₂)₉Si(OCH₃)₃

(5) CF₃COO(CH₂)₁₅Si(OCH₃)₃

(6) CF₃(CF₂)₅(CH₂)₂Si(OCH₃)₃

(7) CF₃CH₂O(CH₂)₁₅Si(OC₂H₅)₃

(8) CF₃(CH₂)₃Si(CH₃)₂(CH₂)₁₅Si(OC₂H₅)₃

(9) CF₃(CF₂)₅(CH₂)₂Si(CH₃)₂(CH₂)₉Si(OC₂H₅)₃

(10) CF₃(CF₂)₇(CH₂)₂Si(CH₃)₂(CH₂)₉Si(OC₂H₅)₃

(11) CF₃COO(CH₂)₁₅Si(OC₂H₅)₃

(12) CF₃(CF₂)₅(CH₂)₂Si(OC₂H₅)₃

(21) CH₃CH₂O(CH₂)₁₅Si(OCH₃)₃

(22) CH₃(CH₂)₃Si(CH₃)₂(CH₂)₁₅Si(OCH₃)₃

(23) CH₃(CH₂)₅(CH₂)₂Si(CH₃)₂(CH₂)₉Si(OCH₃)₃

(24) CH₃(CH₂)₉Si(CH₃)₂(CH₂)₉Si(OCH₃)₃

(25) CH₃COO(CH₂)₁₅Si(OCH₃)₃

(26) CH₃(CH₂)₇Si(OCH₃)₃

(27) CH₃CH₂O(CH₂)₁₅Si(OC₂H₅)₃

(28) CH₃(CH₂)₃Si(CH₃)₂(CH₂)₁₅Si(OC₂H₅)₃

(29) CH₃(CH₂)₇Si(CH₃)₂(CH₂)₉Si(OC₂H₅)₃

(30) CH₃(CH₂)₉Si(CH₃)₂(CH₂)₉Si(OC₂H₅)₃

(31) CH₃COO(CH₂)₁₅Si(OC₂H₅)₃

(32) CH₃(CH₂)₇Si(OC₂H₅)₃

Examples of applicable condensation catalysts include metal salts, such as metal carboxylate salts, metal carboxylate esters, polymers based on a metal carboxylate salt, chelates based on a metal carboxylate salt, titanate esters, and chelates based on a titanate ester.

The amount of the condensation catalyst to be added is preferably in the range of 0.2 to 5 mass percent of the alkoxysilane compound, and more preferably in the range of 0.5 to 1 mass percent.

Specific examples of applicable metal carboxylate salts include tin (II) acetate, dibutyltin dilaurate, dibutyltin dioctate, dibutyltin diacetate, dioctyltin dilaurate, dioctyltin dioctate, dioctyltin diacetate, tin (II) dioctate, lead naphthenate, cobalt naphthenate, and iron 2-ethylhexenoate.

Specific examples of applicable metal carboxylate esters include dioctyltin bis-octylithio-glycolate and dioctyltin maleate.

Specific examples of applicable polymers based on a metal carboxylate salt include a polymer of dibutyltin maleate and a polymer of dimethyltin mercaptopropionate.

Specific examples of applicable chelates based on a metal carboxylate salt include dibutyltin bis-acetylacetate and dioctyltin bis-acetyllaurate.

Specific examples of applicable titanate esters include tetrabutyl titanate and tetranonyl titanate.

Specific examples of applicable chelates based on a titanate ester include bis(acetylacetonyl)dipropyl titanate.

The silica fine particles 1 dispersed in the first chemisorption solution containing an alkoxysilane compound are allowed to react in the air at room temperature so that the alkoxysilyl group and the hydroxyl group 2 existing on the surface of each silica fine particle 1 are condensed into the monomolecular film 3 composed of the first silane compound having the structure shown by Chemical Formula 3 or 4 shown below. It should be noted that three single bonds extending from the oxygen atoms are bound to a silicon (Si) atom existing on the surface of each silica fine particle 1 or contained in the adjacent silane compound, and at least one of the three single bonds is bound to a silicon atom existing on the surface of each silica fine particle 1.

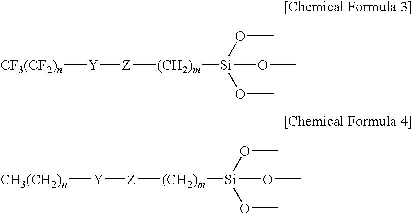

An alkoxysilyl group decomposes in the presence of water, and thus the relative humidity of the air in which the reaction thereof is performed is preferably 45% or lower. In addition, the condensation reaction is inhibited by oil or water adhering to the surfaces of the silica fine particles 1, and thus it is preferable that the silica fine particles 1 are well washed and dried to remove such impurities in advance.

The condensation reaction using any of the metal salts described above as the condensation catalyst would take approximately two hours to complete.

If one or more compounds selected from the group consisting of ketimine compounds, organic acids, aldimine compounds, enamine compounds, oxazolidine compounds, and aminoalkylalkoxysilane compounds are used as the condensation catalyst(s) instead of the metal salts described above, this reaction time can be shortened to approximately ½ to ⅔.

This reaction time can be further shortened by using any of these compounds as a promoter in combination with any of the metal salts described above (any mass ratio in the range of 1:9 to 9:1 is acceptable, but approximately 1:1 is preferable).

For example, provided that the other conditions are unchanged, the use of “H3” manufactured by Japan Epoxy Resins Co., Ltd., a ketimine compound, as the condensation catalyst instead of dibutyltin oxide can shorten the time required to prepare the silica fine particles 4 each having a surface coated with a monomolecular film 3 of a first silane compound to approximately one hour without any loss of the product quality.

Furthermore, provided that the other conditions are unchanged, the use of the mixture of “H3” manufactured by Japan Epoxy Resins Co., Ltd. and dibutyltin bis-acetylacetonate (the mixing ratio is 1:1) can shorten the time required to prepare the silica fine particles 4 each having a surface coated with a monomolecular film 3 of a first silane compound to approximately 20 minutes.

It should be noted that the kind of a ketimine compound used for this purpose is not particularly limited, and examples thereof include 2,5,8-triaza-1,8-nonadiene, 3,11-dimethyl-4,7,10-triaza-3,10-tridecadiene, 2,10-dimethyl-3,6,9-triaza-2,9-undecadiene, 2,4,12,14-tetramethyl-5,8,11-triaza-4,11-pentadecadiene, 2,4,15,17-tetramethyl-5,8,11,14-tetraaza-4,14-octadecadiene, and 2,4,20,22-tetramethyl-5,12,19-triaza-4,19-trieicosadiene.

Also, applicable organic acids are not particularly limited, and examples thereof include formic acid, acetic acid, propionic acid, lactic acid, and malonic acid.

Solvents used to prepare the first chemisorption solution include organic chlorine solvents, hydrocarbon solvents, fluorocarbon solvents, silicone solvents, and mixtures of these solvents. To prevent hydrolysis of an alkoxysilane compound, it is preferable to add a desiccating agent to the solvent or distill the solvent to remove water contained therein. In addition, the boiling point of the solvent is preferably in the range of 50 to 250° C.

Specific examples of applicable solvents include non-aqueous petroleum naphtha, solvent naphtha, petroleum ether, petroleum benzine, isoparaffin, normal paraffin, decaline, industrial gasoline, nonane, decane, kerosene, dimethyl silicone, phenyl silicone, alkyl-denatured silicone, polyether silicone, and dimethyl formamide.

In addition to these solvents, methanol, ethanol, propanol, and any other alcohol solvents, and mixtures of them can be used.

Examples of applicable fluorocarbon solvents include chlorofluorocarbon solvents, “Fluorinate” (manufactured by 3M Company, US), and “Aflude” (manufactured by Asahi Glass Co., Ltd.). These solvents can be independently used or mixed with each other if the components can be mixed well. Furthermore, dichloromethane, chloroform, or any other organic chlorine solvent can be added.

The concentration of the alkoxysilane compound in the first chemisorption solution is preferably in the range of 0.5 to 3 mass percent.

By washing the surface with solvent to remove the excess of the alkoxysilane compound and the condensation catalyst left on the surface after the reaction, silica fine particles 4 each having a surface coated with a monomolecular film 3 composed of a first silane compound are obtained. The cross-sectional structure of one of silica fine particles 4 each having a surface coated with a monomolecular film 3 composed of a first silane compound prepared in this way is schematically shown in FIG. 2B. It should noted that FIG. 2B includes a monomolecular film having the structure shown by Chemical Formula 5 shown below as an example of the monomolecular film 3 composed of a first silane compound.

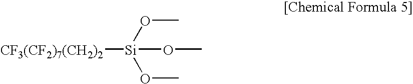

Any solvent can be used as washing solvent as long as it dissolves an alkoxysilane compound. Preferred examples thereof include dichloromethane, chloroform, and N-methylpyrrolidone, which are inexpensive, have high dissolving power, and can be easily removed by air-dry.

If the prepared silica fine particles 4 each having a surface coated with a monomolecular film 3 composed of a first silane compound are left in the air without being washed with solvent after the reaction, the alkoxysilane compound left on the surface is partially hydrolyzed by water contained in the air and forms a silanol group, and this silanol group is condensed with an alkoxysilyl group. As a result, the surface of each silica fine particle 4 having a surface coated with a monomolecular film 3 composed of a first silane compound is coated with an ultrathin polymer film composed of polysiloxane. This polymer film is not fixed to the surface of each silica fine particle 4 having a surface coated with a monomolecular film 3 composed of a first silane compound through covalent bonds, but this has no significant influence on the step A and later manufacturing steps.

In this embodiment, the case where an alkoxysilane compound is used as the first silane compound is described. However, a halosilane compound or an isocyanate silane compound having a carbon fluoride group may be used instead. A first chemisorption solution containing any of these compounds can be prepared and used to form a monomolecular film composed of a first silane compound and coating silica fine particles in the same manner as that containing an alkoxysilane compound, except for the following points: neither a condensation catalyst nor a promoter is needed; an alcohol solvent cannot be used; and a halosilane compound and an isocyanate silane compound are more susceptible to hydrolysis than an alkoxysilane compound and thus the reaction thereof is performed in a dry solvent and dry air (relative humidity is 30% or lower).

Examples of a halosilane compound and an isocyanate silane compound that can be used as the first silane compound include the following compounds (41) to (52):

(41) CF₃CH₂O(CH₂)₁₅SiCl₃

(42) CF₃(CH₂)₃Si(CH₃)₂(CH₂)₁₅SiCl₃

(43) CF₃(CF₂)₅(CH₂)₂Si(CH₃)₂(CH₂)₉SiCl₃

(44) CF₃(CF₂)₇(CH₂)₂Si(CH₃)₂(CH₂)₉SiCl₃

(45) CF₃COO(CH₂)₁₅SiCl₃

(46) CF₃(CF₂)₅(CH₂)₂Si(NCO)₃

(47) CF₃CH₂O(CH₂)₁₅Si(NCO)₃

(48) CF₃(CH₂)₃Si(CH₃)₂(CH₂)₁₅Si(NCO)₃

(49) CF₃(CF₂)₅(CH₂)₂Si(CH₃)₂(CH₂)₉Si(NCO)₃

(50) CF₃(CF₂)₇(CH₂)₂Si(CH₃)₂(CH₂)₉Si(NCO)₃

(51) CF₃COO(CH₂)₁₅Si(NCO)₃

(52) CF₃(CF₂)₅(CH₂)₂Si(NCO)₃

(These are the step A)

In the step B, a silica-based transparent film 6 that is insoluble in a fine particle dispersion liquid (to be used in the step C) and fused onto the transparent fine particles 4 at a lower temperature than a glass substrate 5 to be used is formed on a surface of the glass substrate 5 (see FIG. 3).

The material, shape, and size of the glass substrate 5 are not particularly limited and may be any material used for window glass of a vehicle or a building. Also, any surface-coating film may be formed as long as the resulting surface has active hydrogen groups. It should be noted that the active hydrogen group may be a hydroxyl group, an amino group, or any other group containing active hydrogen.

The silica-based transparent film 6 formed on the surface of the glass substrate 5 is preferably a dry silica gel film formed using a sol-gel method.

The surface and inside of an unsintered dry gel film individually retain more free hydroxyl groups than a surface of a glass substrate without being coated with the transparent film, and thus such a dry gel film can be fused onto silica fine particles 4 at a lower temperature than the glass substrate 5.

A dry silica gel film can be formed by applying a sol solution containing tetraalkoxysilane, such as tetramethoxysilane (Si(OCH₃)₄), a condensation catalyst, and a solvent (an example of a metal alkoxide solution) to a surface of a glass substrate 5 and then evaporating the solvent.

This results in a condensation reaction between a hydroxyl group derived from an alkoxy group hydrolyzed by water existing in the air and another alkoxy group, thereby leading to formation of a transparent dry silica gel film (an example of the silica-based transparent film 6) on the surface of the glass substrate 5.

The kinds of applicable condensation catalysts, promoters, and solvents, the concentration of tetraalkoxysilane, and the amounts of catalysts to be added are the same as those for the first chemisorption solution and thus are not further explained.

The method used to apply the sol solution may be dip coating, spin coating, spraying, screen printing, or any other method.

Also, the thickness of the dry gel film is preferably in the range of 10 to 50 nm, although depending on the particle diameter of silica fine particles 1 used to produce a glass sheet 10.

The cross-sectional structure of a glass substrate 5 coated with a dry silica gel film in this way is schematically shown in FIG. 3.

The use of a glass substrate 5 having a surface coated with such a dry silica gel film as the transparent film in producing a glass sheet 10 enables the heating process in the step E to be carried out at a temperature as low as 300° C. or lower, thereby making it possible to prepare a concavo-convex glass substrate 7 having a surface coated with silica fine particles 1a fused thereonto without any loss of the strength of glass reinforced by air-cooling.

In addition to such a dry silica gel film, any transparent film may be formed and used as the transparent film as long as it is transparent and can be fused onto silica fine particles 1 at a lower temperature than the glass substrate 5. Examples of applicable transparent films include dry gel films composed of alumina, titanium oxide, or the like.

Additionally, addition of phosphoric acid or boric acid to such a sol solution at a concentration of a few percent would result in formation of a dry gel film composed of phosphosilicate glass (PSG) or borosilicate glass (BSG), and accordingly the temperature required in the heating process in the step E would be reduced to approximately 250° C. (These are the step B).

In the step C, a fine particle dispersion liquid in which the silica fine particles 4 each having a surface coated with a monomolecular film 3 composed of the first silica compound is prepared.

The silica fine particles 4 each having a surface coated with a monomolecular film 3 composed of the first silica compound is first added to a solvent, and then this mixture is vigorously stirred using a spring stirrer, a magnetic stirrer, or any other agitation means or ultrasonicated to disperse the silica fine particles 4 each having a surface coated with a monomolecular film 3 composed of the first silica compound uniformly in the solvent.

A solvent that can be used to prepare the fine particle dispersion liquid may be any solvent as long as the silica fine particles 4 are uniformly dispersed in it and the obtained dispersion liquid can be easily removed by evaporation after being applied to the glass substrate 5.

A preferred applicable solvent is any non-aqueous organic solvent excluding water and alcohol solvents when a silane compound having a carbon fluoride group, which is shown by Chemical Formula 1 shown earlier (e.g., the compounds (1) to (12) listed earlier). On the other hand, when a silane compound having a hydrocarbon group, which is shown by Chemical Formula 2 shown earlier (e.g., the compounds (21) to (32) listed earlier), water and alcohol solvents may be used in addition to non-aqueous organic solvents. However, water and alcohol solvents are preferable because they are less toxic and waste fluid thereof is easy to dispose of.

The mass percentage of the silica fine particles 4 each having a surface coated with a monomolecular film 3 composed of a first silica compound is preferably in the range of 0.5 to 5 mass percent. Unfortunately, a mass percentage lower than 0.5 mass percent would necessitate a larger amount of a fine particle dispersion liquid, whereas that higher than 5 mass percent would make it difficult to disperse the silica fine particles 4 uniformly.

The monomolecular film 3 composed of a first silane compound and coating a surface of each silica fine particle 4 reduces the surface energy of the silica fine particles 4, thereby preventing aggregation thereof in the fine particle liquid and improving the dispersion stability.

It should be noted that silica fine particles 4 prepared in the step A, which each have a surface coated with a monomolecular film composed of a first silane compound, are used; however, even a method in which a fine particle dispersion liquid is prepared without the step A by dispersing silica fine particles 1 directly in any of the solvents mentioned above, although resulting in a slightly higher defect density of the surface of the concavo-convex glass substrate 7 prepared in the step E, would have no significant influence on manufacturing of a glass sheet 10 (These are the step C).

In the step D, the silica fine particles 4 are attached to a surface of the glass substrate 5 through the silica-based transparent film 6 by applying the fine particle dispersion liquid to the surface of the glass substrate 5 (a surface of the silica-based transparent film 6) and then drying it.

The method used to apply the fine particle dispersion liquid may be dip coating, spin coating, spraying, screen printing, or any other method. Also, the method used to evaporate the solvent may be chosen from air-dry, reduced-pressure drying, heated-air drying, and other known methods and appropriate combinations thereof depending on the boiling point, vapor pressure, and other characteristics of the solvent.

The cross-sectional structure of a glass substrate 5 having a surface coated with a silica-based transparent film 6 and silica fine particles 4 each having a surface coated with a monomolecular film 3 composed of a first silane compound attached thereto prepared in this way is schematically shown in FIG. 4A (These are the step D).

In the step E, a concavo-convex glass substrate 7 onto which the silica fine particles 4 are fused (i.e., having a surface coated with silica fine particles 1a fused thereonto; see FIG. 4B) is prepared by heating the glass substrate 5 having a surface coated with the silica-based transparent film 6 and the silica fine particles 4 each having a surface coated with a monomolecular film 3 composed of the first silane compound placed thereon in an atmosphere containing oxygen to decompose the monomolecular film 3 composed of the first silane compound and coating a surface of each silica fine particle 4 so that the silica-based transparent film 6 and the silica fine particles 4 are fused to each other on the surface of the glass substrate 5.

The heating process is carried out in an atmosphere containing oxygen and the heating temperature is higher than a temperature at which the glass substrate 5 and the silica fine particles 4 are fused to each other, but is lower than the melting temperatures of the glass substrate 5 and the silica fine particles 4. The higher the heating temperature is, the more firmly the silica fine particles 4 are fused onto the surface of the glass substrate 5; however, a too high heating temperature would cause the silica fine particles to be buried in the glass substrate 5 (or the transparent film 6), and thus is unfavorable.

Fusion of silica fine particles 4 and a glass substrate 5 having a silica-based transparent film 6 can be achieved at a temperature as low as approximately 250 to 300° C. However, a heating temperature in the range of 350 to 400° C. is needed for complete decomposition of the monomolecular film 3 composed of the first silane compound and coating a surface of each silica fine particle 4.

A monomolecular film composed of a first silane compound having a carbon fluoride group would require a heating temperature of approximately 400° C. for complete decomposition. On the other hand, that composed of a first silane compound having a hydrocarbon group can be completely decomposed at a heating temperature of approximately 350° C. Therefore, in the step A, it is preferable to use a first silane compound having a hydrocarbon group because it allows for the use of glass reinforced by air-cooling as the glass substrate 5 without any loss of the strength thereof.

The cross-sectional structure of a concavo-convex glass substrate 7 prepared in this way is schematically shown in FIG. 4B.

It should be noted that, in this embodiment, a glass substrate 5 coated with a silica-based transparent film 6 is used; however, a glass substrate 5 without being coated with a silica-based transparent film 6 may be used as it is by omitting the step B. If a blue glass sheet is used as the glass substrate 5, a preferred heating temperature is approximately 650° C., and the reaction time for heating in the air at 650° C. would be 30 minutes (These are the step E).

In the step F, a portion of the silica fine particles 4 that is not fused onto the surface of the glass substrate 5 is washed away. Although any solvent may be used in this washing process, water is the most preferable because it is harmless and the waste fluid of it can be easily disposed (These are the step F).

In the step G, a glass sheet 10 is produced by forming a chemisorption monomolecular film 8 containing carbon fluoride groups on a surface of the concavo-convex glass substrate 7 having a surface coated with the silica fine particles 1a fused thereonto.

The second chemisorption solution used to prepare the chemisorption monomolecular film 8 containing carbon fluoride groups is prepared by mixing an alkoxysilane compound having a carbon fluoride group (an example of the second silane compound), a condensation catalyst used to promote the condensation reaction between an alkoxysilyl group and a hydroxyl group existing on a surface of the concavo-convex glass substrate 7 (an example of the reactive group), and a non-aqueous organic solvent.

Examples of alkoxysilane compounds having a carbon fluoride group include alkoxysilane compounds shown by the general formula shown earlier (Chemical Formula 1).

The kinds and combinations of applicable condensation catalysts and promoters, the kinds of applicable solvents, the concentrations of the alkoxysilane compound, the condensation catalyst, and the promoter, and the reaction conditions and times for the second chemisorption solution are the same as those for the first chemisorption solution, and thus are not further explained.

The chemisorption monomolecular film 8 containing carbon fluoride groups is covalently bound to an exposed portion of the fused silica fine particles 1a and a portion of the surface of the glass substrate 5 (the surface of the silica-based transparent film 6) excluding the portion onto which the silica fine particles 1a are fused.

In this embodiment, the case where an alkoxysilane compound is used as the second silane compound is described. However, a halosilane compound or an isocyanate silane compound having a carbon fluoride group may be used instead. A second chemisorption solution containing a halosilane compound can be prepared and used to initiate the reaction with a concavo-convex glass substrate 7 in the same manner as that containing an alkoxysilane compound, except for the following points: neither a condensation catalyst nor a promoter is needed; an alcohol solvent cannot be used; and a halosilane compound is more susceptible to hydrolysis than an alkoxysilane compound and thus the reaction thereof is performed in a dry solvent and dry air (relative humidity is 30% or lower).

The cross-sectional structure of a glass sheet 10 prepared in this way is schematically shown in FIG. 1. It should noted that FIG. 1 includes a monomolecular film having the structure shown by Chemical Formula 5 shown earlier as an example of the monomolecular film 8 containing carbon fluoride groups (These are the step G).

The film thickness of the chemisorption monomolecular film 8 containing carbon fluoride groups is only approximately 1 nm, and thus hardly affects concaves and convexes formed on the surface of the glass substrate having a surface coated with silica fine particles 1a fused thereonto. Additionally, these concaves and convexes reduce the apparent surface energy of the glass sheet 10 and achieve a water droplet contact angle of at least 140° (approximately 150° in this embodiment), thereby resulting in a super water-repellent property (so called “lotus effect”).

Furthermore, the surface of the glass substrate 5 of the glass sheet 10 is coated with silica fine particles 1a fused thereonto through the silica-based transparent film 6 and these silica fine particles 1a are harder than glass. Therefore, the wear resistance of the glass sheet is highly improved. In addition, in such a glass sheet 10, the total thickness of the film including the silica fine particles 1a and the chemisorption monomolecular film 8 containing carbon fluoride groups coating the surface of the glass substrate 5 together is approximately 100 nm, and thus this film has no negative influence on transparency of the glass substrate 5.

If a produced glass sheet 10 is left in the air without being washed with solvent after the reaction, the alkoxysilane compound left on the surface is partially hydrolyzed by water contained in the air and thus forms a silanol group, and this silanol group is condensed with a halosilyl group. As a result, the surface of the glass sheet 10 is coated with an ultrathin polymer film composed of polysiloxane. Unlike the monomolecular films, this polymer film is not totally fixed to the surface of the glass sheet 10 through covalent bonds, but has water-repellent, oil-repellent, and antifouling properties due to carbon fluoride groups. Therefore, although being slightly inferior in durability, this glass sheet can be used as a glass sheet 10 without any further treatment.

Meanwhile, examples of alkoxysilane compounds having a carbon fluoride group and being suitable for use in the step G include the compounds (1) to (12) listed earlier.

Also, examples of halosilane and isocyanate silane compounds having a carbon fluoride group and being suitable for use in the step G include the compounds (41) to (52) listed earlier.

### EXAMPLES

The present invention is described in detail below with reference to examples. It should be noted that the present invention is never limited to these examples.

Glass substrates related to the present invention include lenses for optical apparatuses, glass sheets for solar energy systems, and face plates of displays. The following description explains glass sheets for solar water heaters as a representative example.

### Example 1

### (1) Preparation of Silica Fine Particles Each Having a Surface Coated with a Monomolecular Film Containing Carbon Fluoride Groups

Silica fine particles having an average particle diameter of 100 nm were prepared, and then well washed and dried.

Separately, 0.99 parts by weight of (heptadecafluoro-1,1,2,2-tetrahydrodecyl)trimethoxysilane (Chemical Formula 6; manufactured by Shin-Etsu Chemical Co., Ltd.) and 0.01 parts by weight of dibutyltin bis-acetylacetonate (a condensation catalyst) were weighed and then dissolved in 100 parts by weight of a hexamethyldisiloxane solvent to prepare a first chemisorption solution.

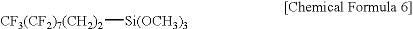

To this first chemisorption solution, dry silica fine particles were added. The mixture was stirred and allowed to react in the air (relative humidity: 45%) for approximately one hour.

After that, the silica fine particles were washed with chloroform to remove the excess of the alkoxysilane compound and dibutyltin bis-acetylacetonate.

### (2) Formation of a Silica-Based Transparent Film on a Surface of a Glass Substrate

A glass sheet for a solar water heater was prepared, and then well washed and dried.

Separately, 0.99 parts by weight of tetramethoxysilane (Si(OCH₃)₄) and 0.01 parts by weight of dibutyltin diacetylacetonate (a condensation catalyst) were weighed and then dissolved in 100 parts by weight of hexamethyldisiloxane solvent to prepare a sol solution. This sol solution was applied to a window glass sheet of an automobile, and the solvent was evaporated so that tetramethoxysilane was hydrolyzed and dealcoholized. As a result, a silica-based transparent film (a dry silica gel film) having a thickness of approximately 50 nm and containing a lot of hydroxyl groups was formed.

### (3) Application of a Fine Particle Solution to the Surface of the Glass Substrate

One part by weight of the silica fine particles obtained in (1), which each had a surface coated with a monomolecular film containing carbon fluoride groups, was added to 99 parts by weight of xylene, and the mixture was vigorously stirred to prepare a fine particle dispersion liquid.

This fine particle dispersion liquid was applied to the surface of the glass sheet for a solar water heater obtained in (2), which was coated with a transparent film consisting of a dry silica gel film, and the solvent was evaporated. As a result, a glass substrate having a surface to which the silica fine particles each having a surface coated with a monomolecular film containing carbon fluoride groups were attached was obtained.

### (4) Preparation of a Concavo-Convex Glass Substrate onto which the Silica Fine Particles are Fused

This glass substrate, which had a surface to which the silica fine particles each having a surface coated with a monomolecular film containing carbon fluoride groups were attached, was sintered in the air at 600° C. for 30 minutes. As a result, the monomolecular film containing carbon fluoride groups, which coated surfaces of the silica fine particles, was decomposed and removed. At the same time, the silica fine particles were fused onto the surface of the glass substrate. After that, a portion of the silica fine particles that was not fused to the surface of the glass substrate was washed away with water, and thus a concavo-convex glass substrate onto which the silica fine particles were fused so as to form a monolayer was obtained. It should be noted that the chemisorption monomolecular film existing on the surface of each silica fine particles was completely decomposed and removed, but no inter-particle fusion of the silica fine particles was observed because their melting point was much higher than 700° C.

### (5) Formation of a Chemisorption Monomolecular Film Containing Carbon Fluoride Groups

One part by weight of (heptadecafluoro-1,1,2,2-tetrahydrodecyl)trichlorosilane (Chemical Formula 7; manufactured by Shin-Etsu Chemical Co., Ltd.) was dissolved in 100 parts by weight of dehydrated nonane to prepare a second chemisorption solution.

This second chemisorption solution was applied to the surface of the glass sheet for a solar water heater prepared in (4) so as to have a surface coated with the silica fine particles fused thereonto, and then allowed to react in dry air with a relative humidity of 30% or lower. After the reaction, the glass sheet was washed with a chlorofluorocarbon solvent to remove an unreacted portion of the trichlorosilane compound.

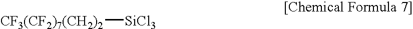

The apparent water droplet contact angle of the resulting water-repellent, oil-repellent, and antifouling glass sheet for a solar water heater was measured to be approximately 145°.

This water-repellent, oil-repellent, and antifouling glass sheet for a solar water heater was mounted on a solar water heater and tested for practical utility. The test results showed that substantially no airborne dust or raindrop stains were found on the glass sheet and the initial heat collection efficiency was improved by an average of approximately 3% from that measured for a solar water heater equipped with normal glass. After one-year use, the solar water heater equipped with normal glass had dirt and stains on its surface and showed a decrease by approximately 30% in the light use efficiency, whereas the solar water heater equipped with this water-repellent, oil-repellent, antifouling glass sheet showed substantially no decrease in the efficiency due to dirt or stains.

### Example 2

Using a method similar to that used in Example 1, a solar battery coated with an antireflection film whose cross-section in the vicinity of the surface thereof had a fractal structure (a water droplet contact angle was 153°) could be produced. The procedures were as follows: fine particles with different particle diameters (fine particles having a particle diameter of 200 nm and those having a particle diameter of 50 nm were mixed in a ratio of approximately 1:10) were fused onto a surface of a transparent glass substrate, which was to be used as the light incidence surface of a solar battery, to prepare a concavo-convex glass substrate whose surface had a fractal structure; and after formation of the solar battery cell, a chemisorption monomolecular film containing carbon fluoride groups (a water-repellent, oil-repellent, and antifouling monomolecular film) was formed thereon.

The obtained solar battery cell was also tested for practical utility. The test results showed that substantially no airborne dust or raindrop stains were found on the solar battery even after half a year and the light use efficiency was improved by an average of approximately 3% from that measured for a solar battery equipped with normal glass. After one-year use, the solar battery equipped with normal glass had dirt and stains on its surface and showed a decrease by approximately 30% in the light use efficiency, whereas the solar battery equipped with the antireflection film according to the present invention showed substantially no decrease in the efficiency due to dirt or stains.

Although the water droplet contact angle was approximately 153° in this solar battery, in practice, a water droplet contact angle of 140° or larger resulted in an equivalent effect.

The test results described above demonstrate that a solar battery and a solar water heater equipped with an antireflection film according to the present invention are excellent in terms of operation efficiency and durability.

Meanwhile, although a water-repellent, oil-repellent, and antifouling antireflection film according to the present invention was used in a solar water heater in Example 1 and in a solar battery in Example 2, applications of the present invention are not limited to such devices and include any instrument based on solar energy, such as a greenhouse, of course.

### Example 3

Using a method similar to that used in Example 1, a solar battery coated with an antireflection film whose cross-section in the vicinity of the surface thereof had a fractal structure (a water droplet contact angle was 153°) as shown in FIG. 4 could be produced. The procedures were as follows: fine particles with different particle diameters (fine particles having a particle diameter of 200 nm and those having a particle diameter of 50 nm were mixed in a ratio of approximately 1:10) were fused onto a surface of a transparent glass substrate, which was to be used as the light incidence surface of a solar battery, to prepare a concavo-convex glass substrate whose surface had a fractal structure; and after formation of the solar battery cell, a chemisorption monomolecular film containing carbon fluoride groups (a water-repellent, oil-repellent, and antifouling monomolecular film) was formed thereon.

The obtained solar battery cell was also tested for practical utility. The test results showed that substantially no airborne dust or raindrop stains were found on the solar battery even after half a year and the light use efficiency was improved by an average of approximately 3% from that measured for a solar battery equipped with normal glass. After one-year use, the solar battery equipped with normal glass had dirt and stains on its surface and showed a decrease by approximately 30% in the light use efficiency, whereas the solar battery equipped with the antireflection film according to the present invention showed substantially no decrease in the efficiency due to dirt or stains.

Although the water droplet contact angle was approximately 153° in this solar battery, in practice, a water droplet contact angle of 140° or larger resulted in an equivalent effect.

The test results described above demonstrate that a solar battery and a solar water heater equipped with an antireflection film according to the present invention are excellent in terms of operation efficiency and durability.

Meanwhile, although a water-repellent, oil-repellent, and antifouling antireflection film according to the present invention was used in a solar water heater in Example 1 and in a solar battery in Example 2, applications of the present invention are not limited to such devices and include any instrument based on solar energy, such as a greenhouse, of course.

### Example 4

Using a method similar to that used in Example 1, a lens was coated with a water-repellent, oil-repellent, and antifouling antireflection film. This lens was mounted in an optical apparatus and tested for practical utility, and the test results showed that the lens was almost free from fingerprints and exhibited light transmission and other optical characteristics comparable to those of an antireflection multilayer film and an excellent antifouling property.

### Example 5

Using a method similar to that used in Example 1, a CRT display was coated with a water-repellent, oil-repellent, and antifouling antireflection film. This CRT display was tested for practical utility, and the test results showed that the display was almost free from fingerprints and could reduce mirroring of room lights or the like on the surface of the face plate at a high efficiency, and thus had greatly improved visibility.

Of course, this technique can be applied also to face plates of PDP and LCD in accordance with the same principle.

### BRIEF DESCRIPTION OF THE DRAWINGS

FIG. 1 is an explanatory diagram schematically showing the cross-sectional structure of a glass sheet coated with a water-repellent, oil-repellent, and antifouling antireflection film according to an embodiment of the present invention (hereinafter, referred to as a “glass sheet”).

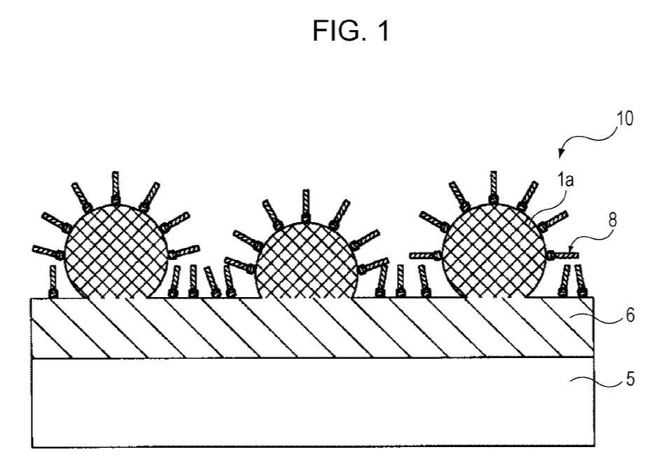

FIGS. 2A and 2B are enlarged schematic diagrams each illustrating the step of forming a monomolecular film containing carbon fluoride groups on surfaces of silica fine particles in a method for manufacturing the glass sheet mentioned above at the molecular level. FIG. 2A represents the cross-sectional structure of a surface of one of the silica fine particles before the reaction, whereas FIG. 2B represents that of one of the silica fine particles each coated with a monomolecular film containing carbon fluoride groups.

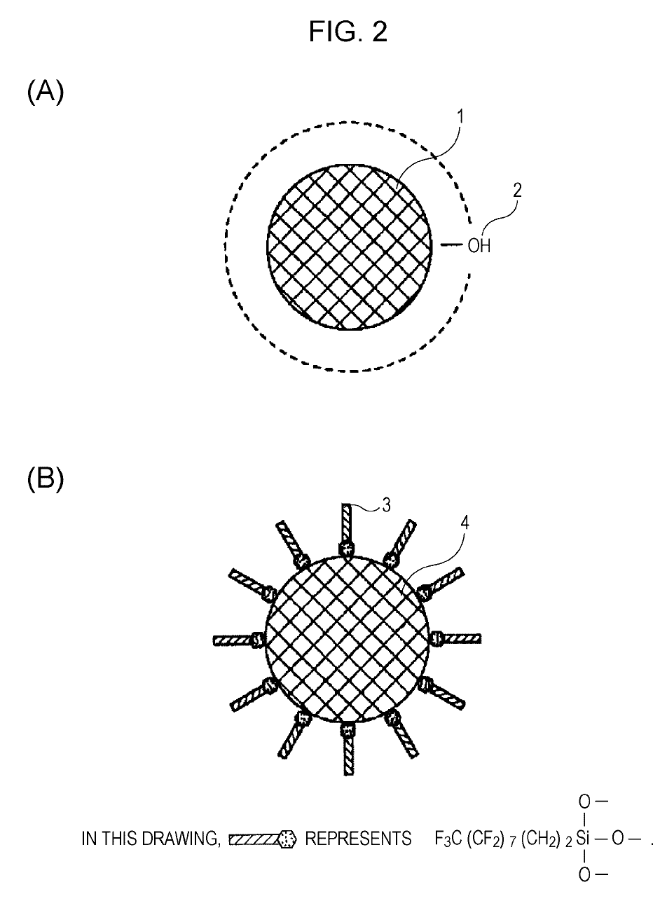

FIG. 3 is a schematic diagram showing the cross-sectional structure of a glass substrate coated with a silica-based transparent film in the course of a method for manufacturing the glass sheet.

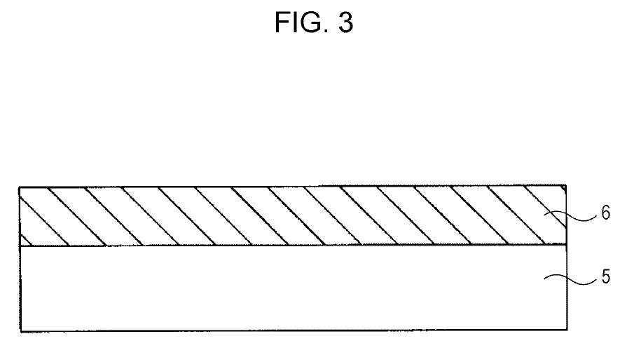

FIG. 4A is an explanatory diagram schematically showing the state of a surface of a glass substrate coated with a silica-based transparent film after attachment of silica fine particles each coated with a monomolecular film containing carbon fluoride groups thereto in the step D, whereas FIG. 4B is an explanatory diagram schematically showing the state of the surface of the glass substrate onto which the silica fine particles are fused in the step E.

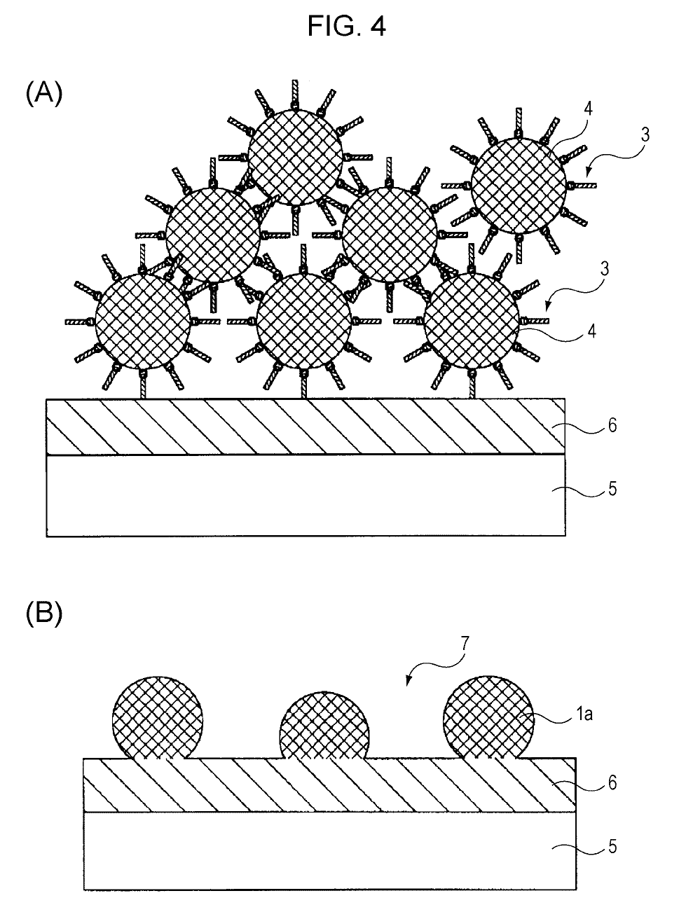

FIG. 5 is an explanatory diagram schematically showing the cross-sectional structure of a glass sheet whose surface has a fractal structure.

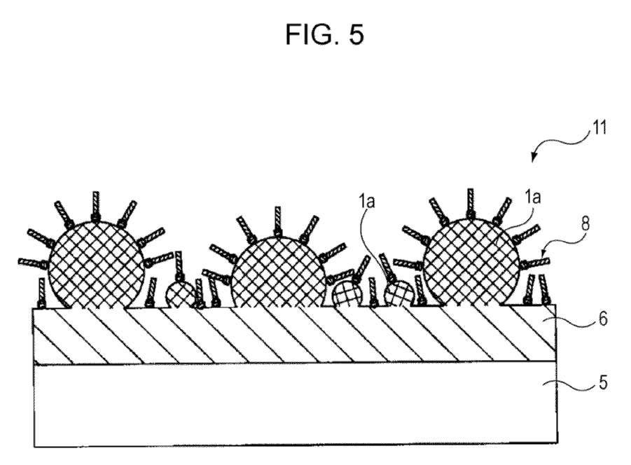

### REFERENCE NUMERALS

1: silica fine particle; 1a: fused silica fine particle; 2: hydroxyl group; 3: monomolecular film of a first silane compound; 4: silica fine particle; 5: glass substrate; 6: silica-based transparent film; 7: concavo-convex glass substrate; 8: chemisorption monomolecular film containing carbon fluoride groups; 10: glass sheet; 11: water-repellent, oil-repellent, and antifouling glass sheet whose surface has a fractal structure

1. A water-repellent, oil-repellent, and antifouling antireflection film comprising a plate substrate, water-repellent, oil-repellent, and antifouling transparent fine particles fused onto a surface of the substrate, and a film composed of a water-repellent, oil-repellent, and antifouling substance and coating a portion of the surface of the substrate excluding the portion onto which the transparent fine particles are fused.

2. The water-repellent, oil-repellent, and antifouling antireflection film according to claim 1, wherein the surface of each of the transparent fine particles is partially fused onto the surface of the substrate and the remaining exposed surface thereof is coated with the film composed of a water-repellent, oil-repellent, and antifouling substance.

3. The water-repellent, oil-repellent, and antifouling antireflection film according to claim 2, wherein the film composed of a water-repellent, oil-repellent, and antifouling substance is covalently bound to a surface of each of the transparent fine particles and the surface of the substrate.

4. The water-repellent, oil-repellent, and antifouling antireflection film according to claim 1, wherein the transparent fine particles may be transparent fine particles with different particle diameters.

5. The water-repellent, oil-repellent, and antifouling antireflection film according to claim 1, wherein the film composed of a water-repellent, oil-repellent, and antifouling substance contains a —CF₃ group.

6. The water-repellent, oil-repellent, and antifouling antireflection film according to claim 1, wherein the transparent fine particles are any of silica fine particles, alumina fine particles, or zirconia fine particles being translucent and having a softening point higher than that of the surface of the substrate.

7. The water-repellent, oil-repellent, and antifouling antireflection film according to claim 1, wherein the particle diameter of the transparent fine particles is smaller than 400 nm.

8. The water-repellent, oil-repellent, and antifouling antireflection film according to claim 1, wherein a water contact angle is equal to or larger than 140°.

9. The water-repellent, oil-repellent, and antifouling antireflection film according to claim 1, wherein a transparent film that is fused onto the transparent fine particles at a lower temperature than the substrate is used to fuse the transparent fine particles onto the surface of the glass substrate and the film composed of a water-repellent, oil-repellent, and antifouling substance coats a portion of the substrate excluding the portion onto which the transparent fine particles are fused through the transparent film.

10. A lens having a surface coated with the water-repellent, oil-repellent, and antifouling antireflection film according to claim 1.

11. A glass sheet having a surface coated with the water-repellent, oil-repellent, and antifouling antireflection film according to claim 1.

12. Glass having a surface coated with the water-repellent, oil-repellent, and antifouling antireflection film according to claim 1.

13. An optical apparatus equipped with the lens having a surface coated with a water-repellent, oil-repellent, and antifouling antireflection film according to claim 10.

14. A solar energy system equipped with the glass sheet having a surface coated with a water-repellent, oil-repellent, and antifouling antireflection film according to claim 11.

15. A display equipped with the glass having a surface coated with a water-repellent, oil-repellent, and antifouling antireflection film according to claim 12.

16. A method for manufacturing a water-repellent, oil-repellent, and antifouling antireflection film comprising:
a step C of preparing a fine particle dispersion liquid in which transparent fine particles are dispersed;
a step D of attaching the transparent fine particles to a surface of a substrate by applying the fine particle dispersion liquid to the surface of the substrate and then drying it;
a step E of fusing the transparent fine particles onto the surface of the substrate by heating the substrate having a surface to which the transparent fine particles are attached at a temperature lower than a softening point of the transparent fine particles;
a step F of washing away a portion of the transparent fine particles that are not fused onto the surface of the substrate; and
a step G of forming a film composed of a water-repellent, oil-repellent, and antifouling substrate on a fine-particle-fused substrate, i.e., the substrate having a surface onto which the transparent fine particles are fused.

17. The method for manufacturing a water-repellent, oil-repellent, and antifouling antireflection film according to claim 16, further comprising a step B of coating a surface of the substrate with a transparent film that is insoluble in the fine particle dispersion liquid and fused onto the transparent fine particles at a lower temperature than the substrate before the step D.

18. The method for manufacturing a water-repellent, oil-repellent, and antifouling antireflection film according to claim 17, wherein a sol-gel method is used to form the transparent film.

19. The method for manufacturing a water-repellent, oil-repellent, and antifouling antireflection film according to claim 17, wherein a temperature used in a heating process in the step E is at least 250° C. and lower than softening points of the substrate and the transparent fine particles.

20. The method for manufacturing a water-repellent, oil-repellent, and antifouling antireflection film according to claim 16, further comprising a step A of coating the transparent fine particles with a monomolecular film composed of a first silane compound having a linear group, in which transparent fine particles “a” are dispersed in a first chemisorption solution containing the first silane compound and a non-aqueous organic solvent to initiate a reaction between a silyl group of the first silane compound and a reactive group existing on a surface of the transparent fine particles “a”, wherein a heating process in the step E is carried out in an atmosphere containing oxygen.

21. The method for manufacturing a water-repellent, oil-repellent, and antifouling antireflection film according to claim 20, wherein an organic solvent is used to prepare the fine particle dispersion liquid and the linear group is a carbon fluoride group.

22. The method for manufacturing a water-repellent, oil-repellent, and antifouling antireflection film according to claim 20, wherein water, an alcohol, or a mixed solvent thereof is used to prepare the fine particle dispersion liquid and the linear group is a hydrocarbon group.

23. The method for manufacturing a water-repellent, oil-repellent, and antifouling antireflection film according to claim 16, wherein formation of the film composed of a water-repellent, oil-repellent, and antifouling substance in the step G is achieved by bringing a second chemisorption solution containing a second silane compound having a carbon fluoride group and a non-aqueous organic solvent into contact with the fine-particle-fused substrate to initiate a reaction between a silyl group of the second silane compound and a reactive group existing on a surface of the fine-particle-fused substrate.

24. The method for manufacturing a water-repellent, oil-repellent, and antifouling antireflection film according to claim 23, wherein, in the step G, an unreacted portion of the second silane compound is washed away after the reaction between a silyl group and a reactive group.

25. The method for manufacturing a water-repellent, oil-repellent, and antifouling antireflection film according to claim 23, wherein the first silane compound contained in the first chemisorption solution and/or the second silane compound contained in the second chemisorption solution is an alkoxysilane compound.

26. The method for manufacturing a water-repellent, oil-repellent, and antifouling antireflection film according to claim 23, wherein the first silane compound contained in the first chemisorption solution and/or the second silane compound contained in the second chemisorption solution is a halosilane compound.

27. The method for manufacturing a water-repellent, oil-repellent, and antifouling antireflection film according to claim 23, wherein the first silane compound contained in the first chemisorption solution and/or the second silane compound contained in the second chemisorption solution is an isocyanate silane compound.

28. The method for manufacturing a water-repellent, oil-repellent, and antifouling antireflection film according to claim 25, wherein those containing the alkoxysilane compound of the first and second chemisorption solutions further contain at least one compound selected from the group consisting of metal carboxylate salts, metal carboxylate esters, polymers based on a metal carboxylate salt, chelates based on a metal carboxylate salt, titanate esters, and chelates based on a titanate ester as a condensation catalyst.

29. The method for manufacturing a water-repellent, oil-repellent, and antifouling antireflection film according to claim 25, wherein those containing the alkoxysilane compound of the first and second chemisorption solutions further contain at least one compound selected from the group consisting of ketimine compounds, organic acids, aldimine compounds, enamine compounds, oxazolidine compounds, and aminoalkylalkoxysilane compounds as a condensation catalyst.

30. The method for manufacturing a water-repellent, oil-repellent, and antifouling antireflection film according to claim 28, wherein at least one compound selected from the group consisting of ketimine compounds, organic acids, aldimine compounds, enamine compounds, oxazolidine compounds, and aminoalkylalkoxysilane compounds is additionally used as a promoter.
